(19) United States
(12) Patent Application Publication
(10) Pub. No.: US 2025/0148580 A1
(43) Pub. Date: May 8, 2025

(54) ELECTRONIC DEVICE AND IMAGE PROCESSING METHOD THEREFOR

(71) Applicant: SAMSUNG ELECTRONICS CO., LTD., Suwon-si (KR)

(72) Inventor: Daesung CHO, Suwon-si (KR)

(73) Assignee: SAMSUNG ELECTRONICS CO., LTD., Suwon-si (KR)

(21) Appl. No.: 19/016,880

(22) Filed: Jan. 10, 2025

Related U.S. Application Data
(63) Continuation of application No. PCT/KR2023/010352, filed on Jul. 19, 2023.

(30) Foreign Application Priority Data
Sep. 6, 2022 (KR) 10-2022-0113029

(51) Int. Cl. G06T 5/73; G06T 5/70; G06T 5/94

(52) U.S. Cl. CPC G06T 5/73; G06T 5/70; G06T 5/94; G06T 2207/10024

(57) ABSTRACT

Disclosed is an electronic device that obtains a focus map based on importance information per region included in an input image, obtains reliability information per region of the focus map based on at least one of brightness information or contrast information of the input image and information included in the focus map, identifies sensitivity information of the focus map according to each of at least one type of image quality processing, and image-quality processes the input image according to the at least one type of image quality processing based on the focus map, the reliability information per region of the focus map, and the sensitivity information; and control the display to display the image-quality processed input image.

### CROSS-REFERENCE TO RELATED APPLICATIONS

This application is a bypass continuation application of International Application No. PCT/KR2023/010352 designating the United States, filed on Jul. 19, 2023, in the Korean Intellectual Property Receiving Office and claiming priority to Korean Patent Application No. 10-2022-0113029, filed on Sep. 6, 2022, in the Korean Intellectual Property Office, the disclosures of which are incorporated by reference herein in their entireties.

### BACKGROUND

### 1. Field

The disclosure relates to an electronic device and an image processing method therefor and more particularly, to an electronic device performing image quality processing per region by using a focus map and an image processing method therefor.

### 2. Description of Related Art

With the development of electronic technologies, various types of electronic devices have been developed and distributed. In particular, the development and distribution of display devices such as a TV or a mobile phone have actively proceeded.

To improve an image quality of an input image in the display devices, it is important to distinguish an important interest object region from the other regions and selectively perform image quality processing.

### SUMMARY

According to an aspect of the disclosure, there is provided an electronic device, comprising: a display; memory storing at least one instruction; and one or more processors connected to the display and the memory to control the electronic device, wherein the at least one instruction, when executed by the one or more processors, causes the electronic device to: obtain a focus map based on importance information per region included in an input image; obtain reliability information per region of the focus map based on at least one of brightness information or contrast information of the input image and information included in the focus map; identify sensitivity information of the focus map according to each of at least one type of image quality processing; image-quality process the input image according to the at least one type of image quality processing based on the focus map, the reliability information per region of the focus map, and the sensitivity information; and control the display to display the image-quality processed input image.

The at least one instruction, when executed by the one or more processors, may cause the electronic device to: identify the sensitivity information of the focus map with respect to a first type of image quality processing as relatively low and scale a value included in the focus map to become large; identify the sensitivity information of the focus map with respect to a second type of image quality processing as relatively high and scale the value included in the focus map to become small; and image-quality process the input image according to the at least one type of image quality processing based on the scaled focus map, the reliability information per region of the focus map, and the sensitivity information, wherein the first type of image quality processing includes at least one of noise reduction processing or detail enhancement processing, and wherein the second type of image quality processing includes at least one of contrast ratio enhancement processing, color enhancement processing, or brightness processing.

The at least one instruction, when executed by the one or more processors, may cause the electronic device to: downscale the input image; identify the downscaled image as a plurality of regions and obtain a region map; obtain a plurality of importance values according to a plurality of different characteristics with respect to each of the plurality of regions; and obtain the focus map based on the plurality of importance values, wherein the plurality of different characteristics include at least one of color difference information, skin color information, face probability information, or high frequency information.

The at least one instruction, when executed by the one or more processors, may cause the electronic device to: downscale the brightness information of the input image to a size of the focus map; identify a background brightness value of the input image based on an inverse value of the value included in the focus map and the downscaled brightness information; and obtain a first reliability gain value based on the background brightness value of the input image.

The at least one instruction, when executed by the one or more processors, may cause the electronic device to: based on the background brightness value of the input image being equal to or less than critical brightness, obtain the first reliability gain value in order that a difference value of image quality processing gains between an interest region and a background region included in the input image becomes small.

The at least one instruction, when executed by the one or more processors, may cause the electronic device to: downscale the contrast information of the input image to the size of the focus map; identify local contrast information of the input image based on the inverse value of the value included in the focus map and the downscaled contrast information; and obtain a second reliability gain value based on the local contrast information of the input image.

The at least one instruction, when executed by the one or more processors, may cause the electronic device to: identify a reliability level based on the first reliability gain value and the second reliability gain value; and image-quality process the input image according to the at least one type of image quality processing based on a pixel gain value corresponding to the at least one type of image quality processing identified according to the sensitivity information of the focus map and the reliability level.

The at least one instruction, when executed by the one or more processors, may cause the electronic device to: apply the reliability level to the pixel gain value mapped per pixel region with respect to a specific type of image quality processing to update the pixel gain value; and perform the specific type of image quality processing with respect to the input image based on the updated pixel gain value.

The at least one instruction, when executed by the one or more processors, may cause the electronic device to: apply a preset window to a pixel included in the input image to identify at least one local contrast value; and identify a maximum value among the at least one local contrast value as the local contrast information corresponding to the pixel included in the input image.

The at least one instruction, when executed by the one or more processors, may cause the electronic device to: obtain a filtered focus map by applying at least one of temporal filtering or spatial filtering to the focus map; and obtain the reliability information per region of the focus map based on at least one of the brightness information or the contrast information of the input image and information included in the filtered focus map.

According to an aspect of the disclosure, there is provided a method of processing an image of an electronic device, including: obtaining a focus map based on importance information per region included in an input image; obtaining reliability information per region of the focus map based on at least one of brightness information or contrast information of the input image and information included in the focus map; identifying sensitivity information of the focus map according to each of at least one type of image quality processing; image-quality processing the input image according to the at least one type of image quality processing based on the focus map, the reliability information per region of the focus map, and the sensitivity information; and displaying the image-quality processed input image.

The image-quality processing may include: identifying the sensitivity information of the focus map with respect to a first type of image quality processing as relatively low and scaling a value included in the focus map to become large; identifying the sensitivity information of the focus map with respect to a second type of image quality processing as relatively high and scaling the value included in the focus map to become small; and image-quality processing the input image according to the at least one type of image quality processing based on the scaled focus map, the reliability information per region of the focus map, and the sensitivity information, wherein the first type of image quality processing includes at least one of noise reduction processing or detail enhancement processing, and wherein the second type of image quality processing includes at least one of contrast ratio enhancement processing, color enhancement processing, or brightness processing.

The obtaining the focus map may include: downscaling the input image and identifying the downscaled image as a plurality of regions to obtain a region map; and obtaining a plurality of importance values according to a plurality of different characteristics with respect to each of the plurality of regions and obtaining the focus map based on the plurality of importance values, wherein the plurality of different characteristics includes at least one of color difference information, skin color information, face probability information, or high frequency information.

The obtaining the reliability information per region of the focus map may include: downscaling the brightness information of the input image to a size of the focus map; identifying a background brightness value of the input image based on an inverse value of the value included in the focus map and the downscaled brightness information; and obtaining a first reliability gain value based on the background brightness value of the input image.

According to an aspect of the disclosure, there is provided a non-transitory computer readable medium storing computer instructions that when executed by a processor of an electronic device, cause the electronic device to: obtain a focus map based on importance information per region included in an input image; obtain reliability information per region of the focus map based on at least one of brightness information or contrast information of the input image and information included in the focus map; identify sensitivity information of the focus map according to each of at least one type of image quality processing; image-quality process the input image according to the at least one type of image quality processing based on the focus map, the reliability information per region of the focus map, and the sensitivity information; and display the image-quality processed input image.

### BRIEF DESCRIPTION OF THE DRAWINGS

The above and other aspects and/or features of one or more embodiments of the disclosure will be more apparent from the following detailed description, taken in conjunction with the accompanying drawings, in which:

FIG. 1 is a view for illustrating an embodiment of an electronic device according to an embodiment;

FIG. 2A is a block diagram illustrating a configuration of an electronic device according to an embodiment;

FIG. 2B is a view illustrating a detailed configuration of an example of an electronic device according to an embodiment;

FIG. 3 is a flow chart illustrating an image processing method according to an embodiment;

FIG. 4 is a view illustrating a configuration of functional modules for performing an image processing method according to an embodiment;

FIGS. 5 and 6 are views illustrating a focus map obtainment method according an embodiment;

FIGS. 7 and 8 are views illustrating a reliability information obtainment method according an embodiment;

FIG. 9 is a view illustrating an image quality processing method according to an image quality processing intensity according to an embodiment;

FIG. 10 is a view illustrating a method of calculating an image quality processing intensity according to each type of image quality processing according to an embodiment;

FIGS. 11A and 11B are views illustrating a method of scaling a focus map according to sensitivity with respect to a focus map according to an embodiment;

FIG. 12 is a view illustrating a focus map-based pixel gain calculation method according to an embodiment; and

FIG. 13 is a view illustrating a detailed operation of image quality processing according to an embodiment.

### DETAILED DESCRIPTION

One or more embodiments are described with reference to the appended drawings hereinafter.

The term used in the specification is briefly described and then the disclosure is specifically described.

The terms used in embodiments of the disclosure are selected as general terms which are currently widely used as much as possible in consideration of functions in the disclosure but may be varied depending on intention of those skilled in the art or a precedent, appearance of new technologies, or the like. Also, there is a term which is arbitrarily selected by the applicant in a certain case and in this case, its meaning will be specifically described in the relevant description part of the disclosure. Therefore, the term used in the disclosure should be defined based on the meaning of the term and the entire content throughout the disclosure rather than the simple name of the term.

In the specification, the expressions such as “have”, “may have”, “include”, and “may include” denote the existence of such characteristics (e.g. a numerical value, a function, an operation, and a component such as a part) and do not exclude the existence of additional characteristics.

The expression “at least one of A and/or B” should be interpreted to mean any one of “A” or “B” or “A and B”.

The expressions “1st”, “2nd”, “first”, “second”, or the like used in the specification may be used to describe various elements regardless of any order and/or degree of importance. Also, such expressions are used only to distinguish one element from another element and are not intended to limit the relevant elements.

The description that one element (e.g. a first element) is “(operatively or communicatively) coupled with/to” or “connected to” another element (e.g. a second element) should be interpreted to include both a case where one element is directly coupled to another element and a case where one element is coupled to another element through the other element (e.g. a third element).

Singular expressions include plural expressions, unless obviously differently defined in the context. In the application, the term such as “include” or “consist of” should be construed as designating that there are such characteristics, numbers, steps, operations, components, parts, or a combination thereof described in the specification but not as excluding in advance the existence of or possibility of adding one or more other characteristics, numbers, steps, operations, components, parts, or a combination thereof.

In the disclosure, “module” or “part” may perform at least one function or operation and may be implemented as hardware or software, or as a combination of hardware and software. In addition, a plurality of “modules” or “parts” may be integrated into at least one module and implemented as at least one processor (not shown), excluding a “module” or a “part” that needs to be implemented as specific hardware.

Hereinafter, an embodiment of the disclosure is more specifically described with reference to the appended drawings.

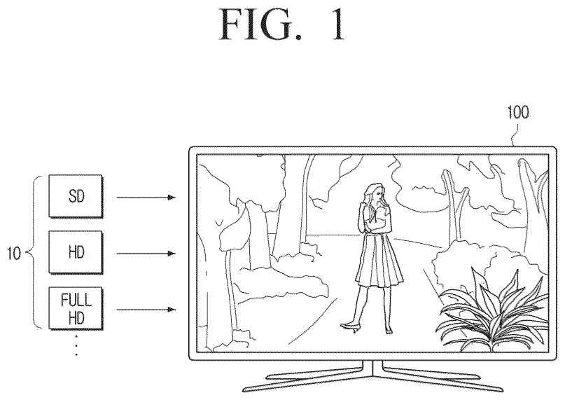

FIG. 1 is a view for illustrating an embodiment of an electronic device according to an embodiment.

The electronic device 100 may be implemented as a TV as shown in FIG. 1 but is not limited thereto, wherein any device having an image processing and/or display function such as a set-top box, a smart phone, a tablet PC, a notebook PC, a head mounted display (HMD), a near eye display (NED), a large format display (LFD), digital signage, a digital information display (DID), a video wall, a projector display, a camera, or the like may be applied without limitations.

The electronic device 100 may receive various compression images or various resolution images. For example, an image processing device 100 may receive an image in a compressed form such as Moving Picture Experts Group (MPEG) (e.g. MP2, MP4, MP7, etc.), Joint Photographic Experts Group (JPEG), Advanced Video Coding (AVC), H.264, H.265, or High Efficiency Video Codec (HEVC). Otherwise, the electronic device 100 may receive any one image of Standard Definition (SD), High Definition (HD), Full HD, or Ultra HD images.

According to an example, there may be an unexpected side effect upon image-quality processing centering around an interest object through saliency region detection. For example, an exact boundary may not be identified between the interest object and a background and partial background region is highlighted together on the boundary of the interest object, thereby resulting in a halo side effect.

Hereinafter, are described various embodiments that the image quality processing is highlighted centering around an interest object region and excess image quality processing is avoided in a background region.

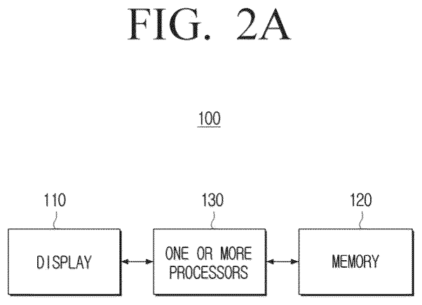

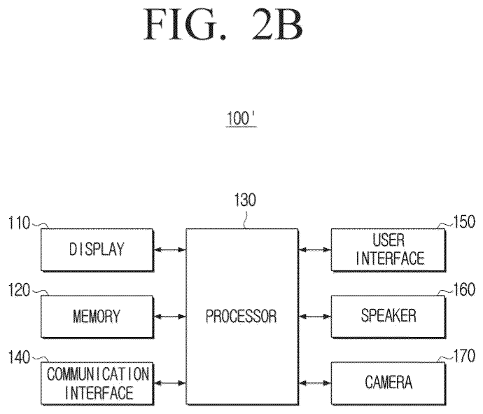

FIG. 2A is a block diagram illustrating a configuration of an electronic device according to an embodiment.

According to FIG. 2A, the electronic device 100 includes a display 110, memory 120, and one or more processors 130.

The display 110 may be implemented as a display including a spontaneous emission element or a display including a non-spontaneous emission element, and backlight. For example, it may be implemented as various types of displays such as a liquid crystal display (LCD), an organic light emitting diode (OLED) display, a light emitting diode (LED), a micro LED, a mini LED, a plasma display panel (PDP), a quantum dot (QD) display, and a quantum dot light-emitting diode (QLED). The display 110 may include a driving circuit which may be implemented in a form such as an a-si TFT, a low temperature poly silicon (LTPS) TFT, or an organic TFT (OTFT), a backlight unit, or the like. Meanwhile, the display 110 may be implemented as a flexible display, a rollable display, a 3D display, a display in which a plurality of display modules are physically connected, or the like.

The memory 120 is electrically connected to the processor 130 and data required for various embodiments of the disclosure may be stored. The memory 120 may be implemented as memory embedded in an electronic device 100′ according to a use for data storage or may be implemented as memory detachable from the electronic device 100′. For example, data for driving the electronic device 100′ is stored in memory embedded in the electronic device 100 and data for an extension function of the electronic device 100′ may be stored in memory detachable from the electronic device 100′. Meanwhile, memory embedded in the electronic device 100′ may be implemented as at least one of volatile memory (e.g. dynamic RAM (DRAM), static RAM (SRAM), or synchronous dynamic RAM (SDRAM), etc.) or non-volatile memory (e.g. one time programmable ROM (OTPROM), programmable ROM (PROM), erasable and programmable ROM (EPROM), electrically erasable and programmable ROM (EEPROM), mask ROM, flash ROM, flash memory (e.g. NAND flash memory, NOR flash memory, etc.), a hard drive, or a solid state drive (SSD)). Also, memory detachable from the electronic device 100′ may be implemented as a memory card (e.g. a Compact Flash (CF) card, a Secure Digital (SD) card, a Micro Secure Digital (Micro-SD) card, a Mini Secure Digital (Mini-SD) card, an extreme Digital (xD) card, a Multi-Media Card (MMC), etc.), external memory connectable to a USB port (e.g. USB memory), etc.

According to an embodiment, the memory 120 may store a computer program including at least one instruction for controlling the electric device 100′.

According to an embodiment, the memory 120 may store an image received from an external device (e.g. a source device), an external storing medium (e.g. a USB), an external server (e.g. webhard), or the like, that is an input image, various data, information, or the like.

According to an embodiment, the memory 120 may store information about a neural network model including a plurality of layers (or a neural network model). Here, storing information about the neural network model may mean storing various information related to an operation of the neural network model, for example, information about a plurality of layers included in the neural network model, and information about a parameter (e.g. a filter coefficient, a bias, etc.) used in each of the plurality of layers.

According to an embodiment, the memory 120 may store various information required for image quality processing, for example, information performing at least one of noise reduction, detail enhancement, tone mapping, contrast enhancement, color enhancement, or frame rate conversion, an algorithm, and an image quality parameter. Also, the memory 110 may store a final output image generated by image processing.

According to an embodiment, the memory 120 may be implemented as single memory storing data generated from various operations according to the disclosure. Meanwhile, according to another embodiment, the memory 120 may be implemented to include a plurality of memory storing each different type of data or storing each data generated from different steps.

In the aforementioned embodiment, it is described that various data is stored in the external memory 120 of the processor 130 but at least part of the data may be stored in memory inside the processor 130 according to at least one embodiment among the electronic device 100′ or the processor 130.

The one or more processors 130 may perform operations of the electronic device 100 according to various embodiments by executing at least one instruction stored in the memory 120.

The one or more processors 130 controls operations of the electronic device 100 overall. Specifically, the processor 130 may be connected to each component of the electronic device 100 to control operations of the electronic device 100 overall. For example, the processor 130 may be electrically connected to the display 110 and memory 150 (FIG. 2B) to control the operations of the electronic device 100 overall. The processor 130 may be configured of one processor or a plurality of processors.

The one or more processors 130 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors 130 may control one or any combination of other components of the electronic device 100 and perform an operation related to communication or data processing. The one or more processors 130 may perform one or more programs or instructions stored in the memory 120. For example, the one or more processors 130 may perform a method according to an embodiment of the disclosure by executing one or more instructions stored in the memory 120.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by the second processor (e.g. an Artificial Intelligence (AI)-dedicated processor).

The one or more processors 130 may be implemented as a single core processor including one core and may be implemented as one or more multi core processors including a plurality of cores (e.g. homogeneous multicores or heterogeneous multicores). If the one or more processors 130 are implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, a processor may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, or a machine learning accelerator but embodiments of the disclosure are not limited thereto. The one or more processors 130 may be referred to as a processor 130 for convenience of the description.

FIG. 2B is a view illustrating a detailed configuration of an example of an electronic device according to an embodiment.

According to FIG. 2B, the electronic device 100′ includes a display 110, memory 120, one or more processors 130, a communication interface 140, a user interface 150, a speaker 160, and a camera 170. The detailed description of components overlapped with the components shown in FIG. 2A among the components shown in FIG. 2B is omitted.

The communication interface 140 may perform communication with an external device. The communication interface 140 may receive an input image in a streaming or download method from an external device (e.g. a source device), an external storing medium (e.g. USB memory), an external server (e.g. webhard), or the like through a communication method such as AP-based Wi-Fi (Wi-Fi, a wireless LAN), Bluetooth, Zigbee, a wired/wireless Local Area Network (LAN), a Wide Area Network (WAN), Ethernet, IEEE 1394, a Mobile High-Definition Link (MHL), Audio Engineering Society/European Broadcasting Union (AES/EBU), an optical method, or a coaxial method. Here, the input image may be any one digital image of a Standard Definition (SD) image, a High Definition (HD) image, a full HD image, or an ultra HD image but is not limited thereto.

The user interface 150 may be implemented as a device such as a button, a touch pad, a mouse, and a keyboard or may be implemented as a touch screen capable of performing the aforementioned display function and also the operation input function together. According to an embodiment, the user interface 150 may be implemented as a transceiver of a remote controller and may receive a remote control signal. The transceiver of the remote controller may receive a remote signal or transmit the remote signal from/to an external remote control device through at least one communication method of an infrared communication method, a Bluetooth communication method, or a Wi-Fi communication method.

The speaker 160 outputs an acoustic signal. For example, the speaker 160 may convert the digital acoustic signal processed in the processor 130 to an analog acoustic signal and then amplify and output the converted analog acoustic signal. For example, the speaker 160. may include at least one speaker unit capable of outputting at least one channel, a D/A converter, an audio amplifier, or the like. According to an embodiment, the speaker 160 may be implemented to output various multichannel acoustic signals. In this case, the processor 130 may control the speaker 160 to enhancement process and output the inputted acoustic signal in order to correspond to enhancement processing of the input image.

The camera 170 may be turned on according to a preset event and perform capturing. The camera 170 may convert the captured image to an electric signal and generate image data based on the converted signal. For example, a subject may be converted to an electric image signal through a semiconductor optical device, a charge coupled device (CCD), and the converted image signal as above may be amplified and converted to a digital signal and then may be signal processed.

The electronic device 100′ may additionally include a tuner and a demodulator according to an embodiment. The tuner (not shown) may receive the RF broadcasting signals by tuning a channel selected by the user among radio frequency (RF) broadcasting signals received through an antenna or all prestored channels. The demodulator (not shown) may receive and demodulate a Digital IF (DIF) signal converted in the tuner and may perform channel demodulation.

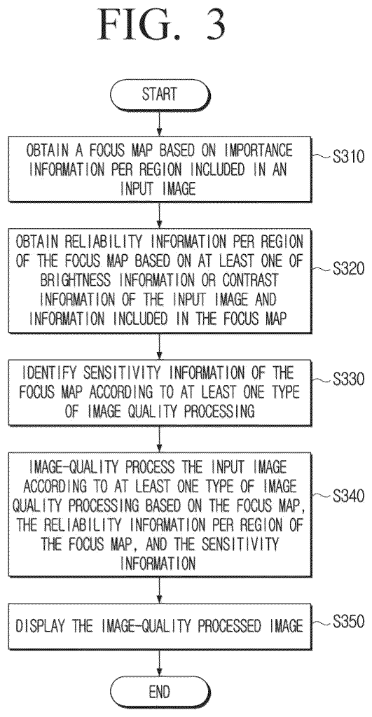

FIG. 3 is a flow chart illustrating an image processing method according to an embodiment.

According to an embodiment shown in FIG. 3, the processor 130 may obtain a focus map based on importance information per region included in the input image (S310).

Here, the region may be a pixel region including at least one pixel. For example, one pixel may be one region but is not limited thereto. Here, the focus map is a map identifying an interest region and a non-interest region and according to an embodiment, it may be implemented to have values of 0 to 255 but is not limited thereto. For example, as each region included in the focus map is close to the interest region, it may have a value of 255 and as it is close to the non-interest region, it may have a value of 0.

Subsequently, the processor 130 may obtain reliability information per region of the focus map based on at least one of brightness information or contrast information of the input image and information included in the focus map (S320).

Here, a contrast may mean a relative difference between one region and another region and may determine a difference with respect to at least one of color or brightness. For example, as a difference between one region and another region becomes greater, a value of the contrast may be large. Reliability information per region of the focus map may include a reliability value with respect to each region included in the focus map and may be information for mitigating a side effect due to inaccuracy of a boundary between the interest object region and the background region upon image-quality processing by using the focus map.

Subsequently, the processor 130 may identify sensitivity information of the focus map according to each of at least one type of image quality processing (S330).

Here, the at least one type of image quality processing may include at least one of noise reduction processing, detail enhancement processing, contrast ratio enhancement processing, color enhancement processing, or brightness processing.

According to an embodiment, sensitivity with respect to the focus map may be different according to each type of image quality processing. For example, sensitivity with respect to the focus map in noise reduction processing and detail enhancement processing may be relatively low compared to contrast ratio enhancement processing, color enhancement processing, or brightness processing. Here, each image quality processing may be performed in a separate Intellectual Property (IP) chip but is not limited thereto, wherein a plurality of image quality processing may be performed in one IP chip or one image quality processing may be performed in a plurality of IP chips.

Subsequently, the processor 130 may image-quality process the input image according to at least one type of image quality processing based on the focus map, the reliability information per region of the focus map, and the sensitivity information (S340).

According to an embodiment, the processor 130 may scale a value included in the focus map based on sensitivity information of the focus map with respect to a specific type of image quality processing and apply a reliability gain of the focus map to the pixel gain value corresponding to the scaled focus map, thereby obtaining a final gain value corresponding to specific image quality processing.

Thereafter, the processor 130 may control the display 110 to display the image-quality processed image (S350).

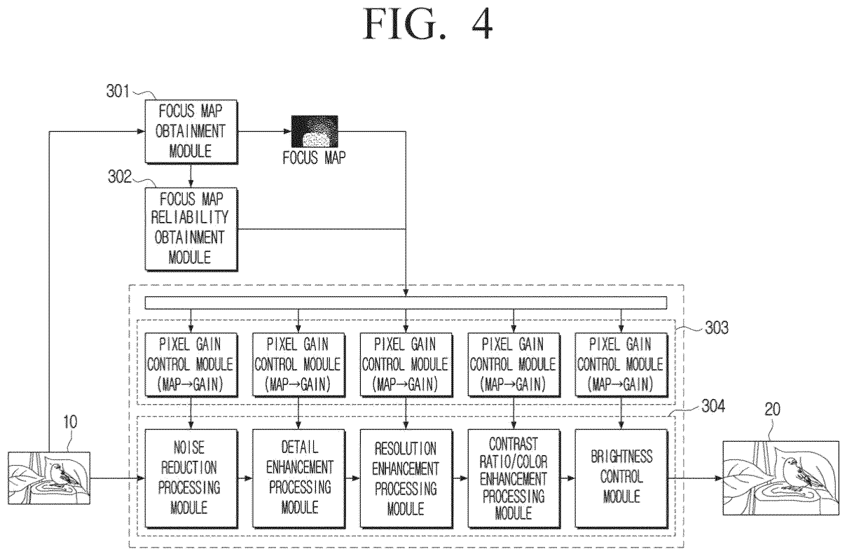

FIG. 4 is a view illustrating a configuration of functional modules for performing an image processing method according to an embodiment.

Each functional module shown in FIG. 4 may be configured of a combination with at least one hardware and/or at least one software.

As shown in FIG. 4, the focus map obtainment module 301 may detect an important region from an input image 10 to obtain the focus map.

The focus map reliability obtainment module 302 may obtain a reliability level with respect to the focus map. For example, the focus map reliability obtainment module 302 may obtain a reliability level with respect to the focus map upon image-quality processing of the interest region or the non-interest region.

The pixel gain control module 303 may control an image quality processing gain used in each image quality processing module 304. For example, the pixel gain control module 303 may enhance an image quality processing gain in the case of the interest region and lower the image quality processing gain in the case of the background region.

The image quality processing module 304 may perform region unit image quality processing centering around the interest object. According to an embodiment, the image quality processing module 304 may include a noise reduction processing module, a detail enhancement processing module, a resolution enhancement processing module, a contrast ratio/color enhancement processing module, and a brightness control module. Meanwhile, it may be merely an example, other image quality processing modules may be added or part of the image quality processing module may be removed.

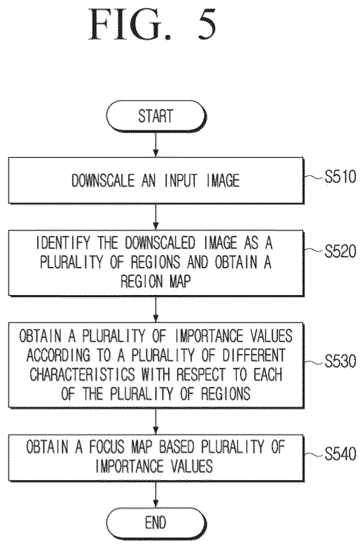

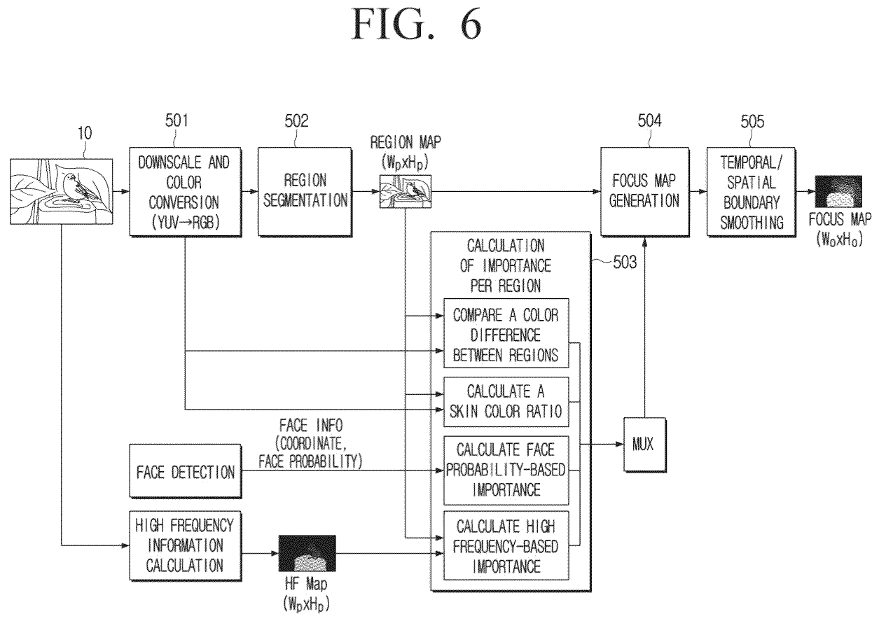

FIGS. 5 and 6 are views illustrating a focus map obtainment method according an embodiment.

According to an embodiment shown in FIG. 5, the processor 130 may downscale the input image (S510). For example, as a downscaling method, various conventional methods including sub-sampling may be used.

For example, as shown in FIG. 6, the processor 130 may downscale resolution (WixHi) (e.g. 1920×1080) of the input image 10 to resolution (WpxHp) (e.g. 240×135). This is for processor 130 to increase efficiency of a memory capacity, a processing speed, or the like in a following process such as region segmentation thereafter (501).

Also, the processor 130 may perform color coordinate conversion if the color coordinate conversion of the input image 10 is needed. In the case of region segmentation processing, the processor may utilize a value of RGB color and thus if the input image 10 is a YUV image, the processor may convert the YUV image to a RGB image (501). According to an embodiment, a sequence of the downscaling and the color coordinate conversion may be changed.

Subsequently, the processor 130 may identify the downscaled image as a plurality of regions to obtain a region map (S520).

For example, as shown in FIG. 6, the processor 130 may identify the downscaled image as a plurality of regions (502). For example, under consideration of the interest region, the non-interest region, the object region, the background region, or the like, the processor may identify the downscaled image as a plurality of regions having a meaning.

Subsequently, the processor 130 may obtain a plurality of importance values according to a plurality of different characteristics with respect to each of a plurality of regions (S530). Here, the plurality of different characteristics may include at least one of color difference information, skin color information, face probability information, or high frequency information.

For example, as shown in FIG. 6, to calculate an importance value of each region, the processor 130 may calculate an importance value based on comparison of a color difference between regions, a ratio of skin color within a region, face probability within a region by utilizing a face detection result, a magnitude of a high frequency component per region, or the like and weighted average the importance value, thereby calculating an importance value per region (503).

Thereafter, the processor 130 may obtain the focus map based on a plurality of importance values (S540).

For example, as shown in FIG. 6, the processor 130 may generate the focus map based on the region map and the importance value per region (504).

Also, the processor 130 may perform temporal smoothing (or temporal filtering) or spatial smoothing (or spatial filtering) for preventing a rapid change of an importance value between image boundaries or adjacent image frames upon image processing per region with respect to the focus map (505).

For example, the processor 130 may apply a Gaussian filter or an average filter of a given window size (e.g. 3×3) to the focus map for spatial smoothing. According to an embodiment, the processor 130 may apply a Gaussian mask to each focus map value included in the focus map to process smoothing. Specifically, the processor 130 may perform filtering with respect to each pixel value while moving the Gaussian mask in order that each focus map value included in the focus map is positioned at a center of the Gaussian mask.

The processor 130 may prevent a rapid change among frames by applying an Infinite Impulse Response (IIR) filter to the focus map for temporal smoothing, that is smoothing among frames. According to an embodiment, the processor 130 may additionally downscale resolution (WoxHo) (e.g. 60×40) of the focus map upon performing smoothing with respect to the focus map.

Meanwhile, the disclosure is not limited to the aforementioned embodiment, wherein the focus map may be obtained by inputting the input image into the trained neural network model. For example, the neural network model may learn a parameter of a layer included in the neural network model by using information with respect to the interest region and a plurality of images corresponding to the information with respect to the interest region. Here, the plurality of images may include various types of images such as a separate static image and a plurality of successive images configuring a moving image.

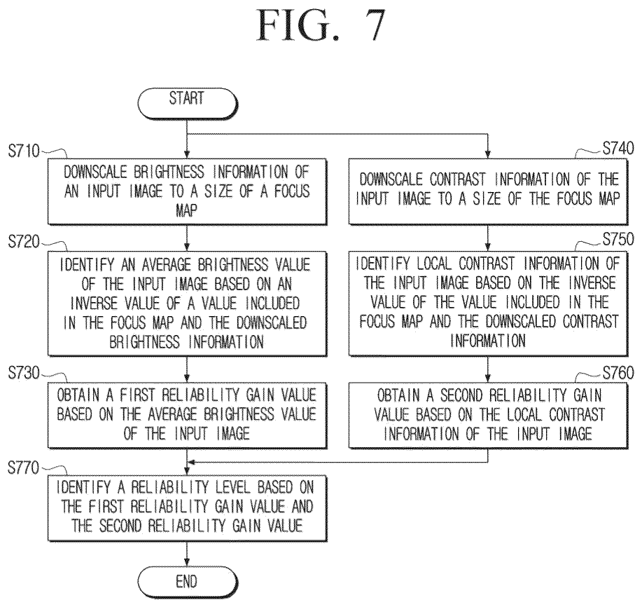

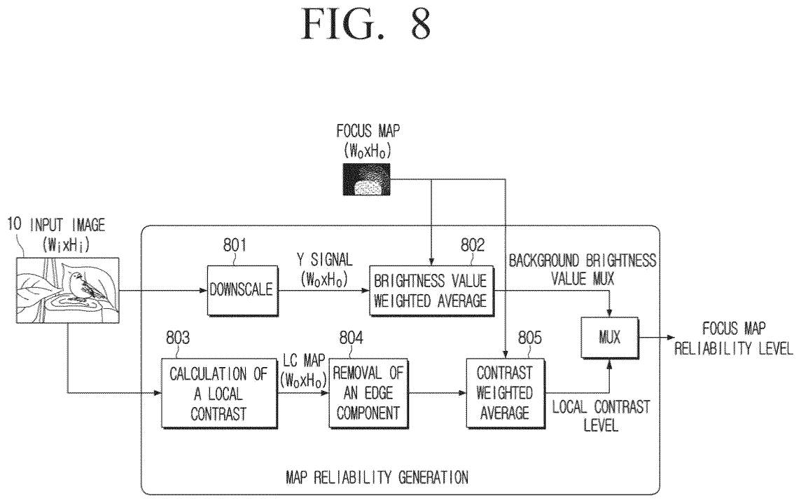

FIGS. 7 and 8 are views illustrating a reliability information obtainment method according an embodiment.

According to an embodiment, the processor 130 may obtain reliability information of the focus map based on at least one of brightness information or contrast information of the input image. Meanwhile, depending on a case, other information may be used for obtaining reliability information of the focus map besides brightness information and contrast information.

According to an embodiment, the reliability information of the focus map may include a reliability level (or a reliability gain) for mitigating a side effect due to inaccuracy of a boundary between the interest object region and the background upon image-quality processing by using the focus map.

According to an embodiment shown in FIG. 7, the processor 130 may downscale brightness information of the input image to a size of the focus map (S710).

For example, as shown in FIG. 8, the processor may downscale Y information (or a Y signal) (WixHi) of the input image to the same size (WoxHo) as that of the focus map.

The processor 130 may identify a background brightness value of the input image based an inverse value of a value included in the focus map and the downscaled brightness information (S720).

For example, as shown in FIG. 8, a brightness value may be calculated in which a weighted value is given to the background region, wherein the weighted value is the inverse value of the focus map (802).

The brightness value in which the weighted value is given to the background region may be similar with an average brightness value of the input image. If the input image is dark overall according to the relevant brightness value, the processor may make a difference of image processing gains between the interest object region and the background region smaller by reducing a gain when processing control of a contrast ratio and/or brightness.

The processor 130 may obtain a first reliability gain value (or a brightness gain value) based on a background brightness value of the input image (S730). According to an embodiment, the processor 130, if the background brightness value of the input image is equal to or less than critical brightness, may obtain the first reliability gain value in order that a difference value of image quality processing gains between the interest region and the background region included in the input region becomes small.

According to an embodiment, the first reliability gain value may be calculated according to Equation 1 below.

$${Mean}_{y} = \frac{{\sum }_{y = 0}^{{H}_{0} - 1} {\sum }_{x = 0}^{{W}_{0} - 1} ( ( 255 - focusMap [ y ] [ x ] ) * Y [ y ] [ x ] )}{{\sum }_{y = 0}^{{H}_{0} - 1} {\sum }_{x = 0}^{{W}_{0} - 1} ( 255 - focusMap [ y ] [ x ] )} \qquad [ Equation 1 ]$$

The processor 130 may downscale contrast information of the input image to a size of the focus map (S740).

With reference to FIG. 8 according to an embodiment, the processor 130 may apply a preset window to a pixel included in the input image to identify at least one local contrast value (803).

For example, a difference between a maximum value and a minimum value of pixels within a specific window size (e.g. 9×9) centering around each pixel in input image resolution may be calculated as a local contrast of the relevant pixel.

According to an embodiment, the processor 130, if a local contrast value corresponding to a pixel included in the input image is plural numbers, may identify a maximum value among these values as the local contrast corresponding to the pixel included in the input image.

According to an embodiment, the processor 130 may remove a contrast value that is equal to or greater than a threshold value among local contrast information and then identify the contrast value as local contrast information of the input image (804).

According to an embodiment, when the contrast information is downscaled to resolution of the focus map, if there are many local contrast values of input resolution corresponding to a pixel position of the downscaled resolution, the processor may map a maximum value of these values to a Local Contrast (LC) map. Also, in the LC map, the processor may remove a contrast value with respect to an edge component of which contrast value is equal to or greater than a threshold value to update the LC map.

The processor 130 may identify local contrast information of the input image based on the inverse value of the value included in the focus map and the downscaled contrast information (S750). The processor 130 may obtain a second reliability gain value based on local contrast information of the input image (S760).

According to an embodiment, the processor 130 may obtain a second reliability gain value (or a LC gain value) based on the LC map and the focus map information as shown in FIG. 8. As above, by using the LC gain value, a side effect on a boundary between the interest object region and the background region may be prevented when controlling a contrast ratio and brightness in an image of a contrast of the background is simple or a pattern image.

According to an embodiment, the second reliability gain value may be calculated according to Equation 2 below.

$$LCgain = \qquad [ Equation 2 ]$$

$$\frac{{\sum }_{y = 0}^{{H}_{0} - 1} {\sum }_{x = 0}^{{W}_{0} - 1} ( ( 255 - focusMap [ y ] [ x ] ) * LCmap [ y ] [ x ] )}{{\sum }_{y = 0}^{{H}_{0} - 1} {\sum }_{x = 0}^{{W}_{0} - 1} ( 255 - focusMap [ y ] [ x ] )}$$

Thereafter, the processor 130 may obtain a reliability level (or a reliability gain value) with respect to the focus map based on the first reliability gain value and the second reliability gain value. According to an embodiment, as shown in FIG. 8, the reliability level (or a reliability gain) may be obtained by muxing the first reliability gain value and the second reliability gain value.

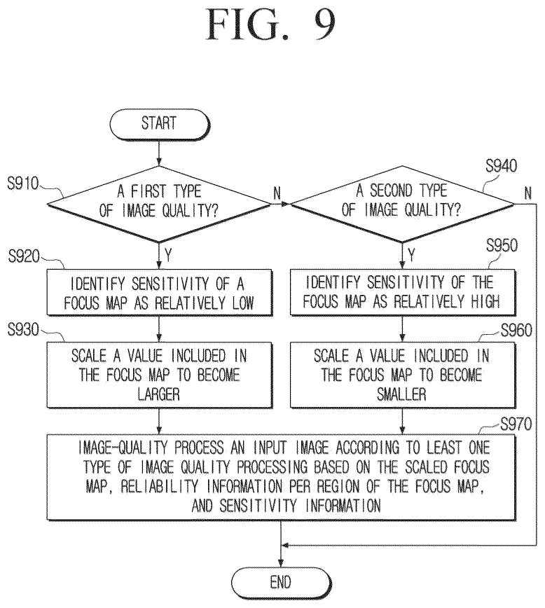

FIG. 9 is a view illustrating an image quality processing method according to an image quality processing intensity according to an embodiment.

According to an embodiment shown in FIG. 9, the processor 130, if performing a first type of image quality processing (S910: Y), may identify sensitivity of the focus map as relatively low (S920) and may scale a value included in the focus map to become larger (S930).

Here, the first type of image quality processing may include at least one of noise reduction processing or detail enhancement processing. This is because image quality processing sensitivity of the interest object region and the background region by the focus map is relatively low with respect to the relevant image quality processing.

If the processor 130 performs a second type of image quality processing (S940: Y), it may identify sensitivity of the focus map as relatively high (S920) and may scale a value included in the focus map to become smaller (S930).

The second type of image quality processing may include at least one of contrast ratio enhancement processing, color enhancement processing, or brightness processing. This is because image quality processing sensitivity of the interest object region and the background region by the focus map is relatively high with respect to the relevant image quality processing.

Thereafter, the processor 130 may image-quality process the input image according to least one type of image quality processing based on the scaled focus map, the reliability information per region of the focus map, and the sensitivity information.

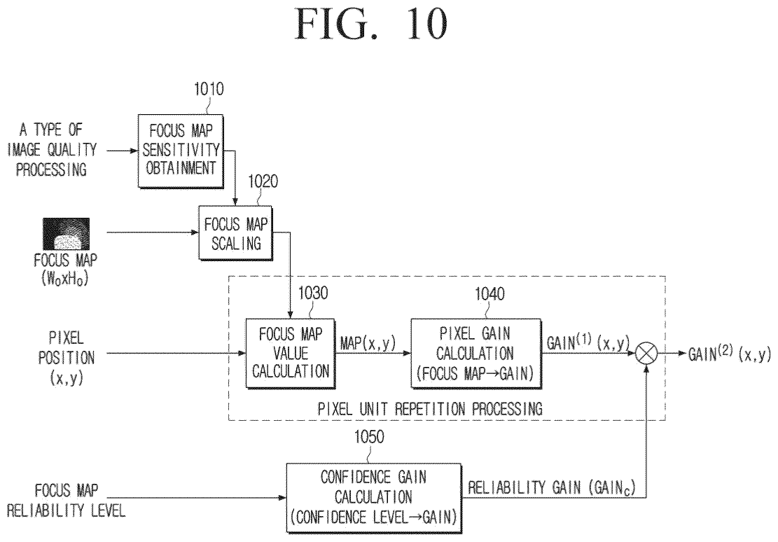

FIG. 10 is a view illustrating a method of calculating an image quality processing intensity according to each type of image quality processing according to an embodiment.

According to an embodiment shown in FIG. 10, the processor 130 may obtain sensitivity information of the focus map according to a type of image quality processing (1010) and then scale the focus map (1020).

As aforementioned, the image quality processing sensitivity of the interest object region and the background region by the focus map is different according to a type of the image quality processing (e.g. noise reduction, detail enhancement, resolution enhancement, contrast ratio/color enhancement, and brightness control) and thus the focus map sensitivity according to the type of the image quality processing may be calculated. According to an embodiment, the processor 130 may update (or scale) a magnitude of a value of the focus map to be utilized for calculation of the image quality processing gain per region based on sensitivity information of the focus map.

Subsequently, the processor 130 may identify a focus map value corresponding to a position of a processing target pixel based on the scaled focus map (1030) and may obtain a pixel gain for image quality processing (1040). For example, a position of the processing target pixel is (x,y), the processor may identify the focus map value corresponding to the relevant pixel position and may obtain the pixel gain G⁽¹⁾(x, y) for the image quality processing.

Then, the processor 130, if the reliability gain (or reliability level) of the focus map is obtained (1050), may apply the reliability gain (gain_{c}) to the pixel gain G⁽¹⁾(x, y) for the image quality processing to obtain the updated pixel gain G⁽²⁾(x, y). For example, the processor 130 may obtain the pixel gain G⁽²⁾(x, y) of which magnitude is scaled by multiplying the pixel gain G⁽¹⁾(x, y) for the image quality processing by the reliability gain (gain_{c}).

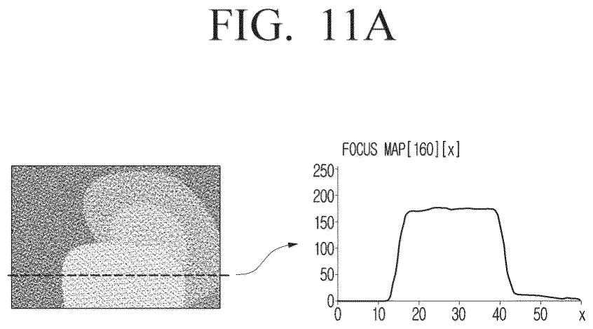

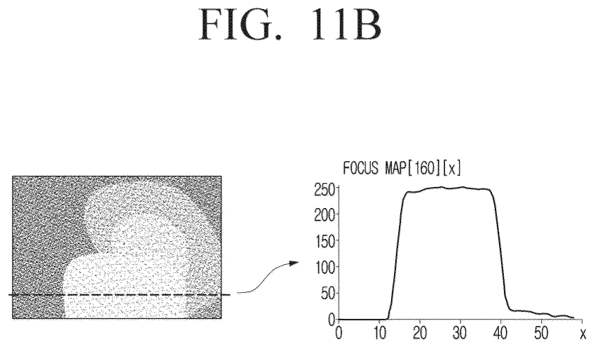

FIGS. 11A and 11B are views illustrating a method of scaling a focus map according to sensitivity with respect to a focus map according to an embodiment.

According to an embodiment, compared to the contrast ratio processing and the brightness control, the noise reduction processing or definition improvement processing has relatively small sensitivity with respect to the focus map.

Accordingly, in the case of the noise reduction processing or the definition improvement processing, the processor 130 may use the focus map where the focus map as shown in FIG. 11A is scaled to an overall large value as shown in FIG. 11B. This is for increasing an effect of the interest region in the case of the noise reduction processing or the definition improvement processing. A right side of FIG. 11A presents a section of a specific pixel before scaling the focus map and FIG. 11B presents a section of the specific pixel after scaling the focus map.

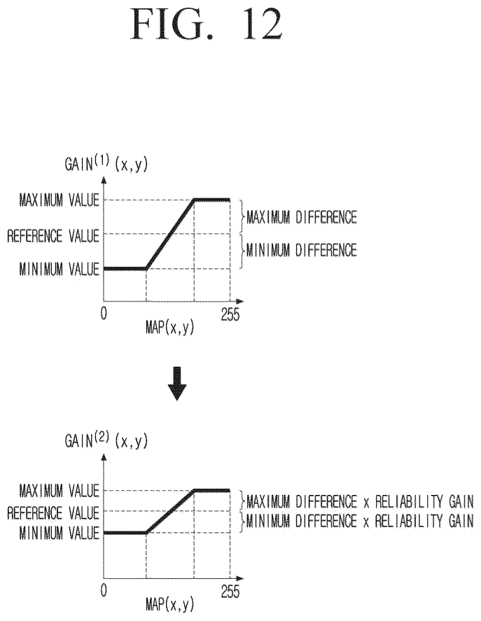

FIG. 12 is a view illustrating a focus map-based pixel gain calculation method according to an embodiment.

According to an embodiment, the processor 130 may map a gain value with respect to each input pixel included in the input image according to a value of the focus map.

According to an embodiment, on an upper drawing of FIG. 12, as a value of the focus map Map(x,y) is close to 0, the gain value is mapped to the background region and as it is close to 255, the gain value is mapped to the interest object region.

In the upper drawing of FIG. 12, based on an image quality processing gain value applicable to each pixel according to the focus map before applying the reliability gain, if the processing target pixel is included in the interest object region, a gain value which is larger than a reference value may be mapped and on the contrary, if it is included in the background region, a gain value which is smaller than the reference value may be mapped.

A lower drawing of FIG. 12 presents an example where the image quality processing gain value is updated according to reliability information of the focus map. According to the lower drawing of FIG. 12, difference information (Diff) of the focus map value compared to a reference value (defValue) may be controlled by the gain value (Gain_{C}) according to reliability information of the focus map. If a reliability value of the focus map is low, the reliability gain (Gain_{C}) becomes small and thus a difference in the image quality processing gains between the interest object region and the background region becomes small and in the opposite case, a difference in the image quality processing gains may become large.

According to an embodiment, an update of the image quality processing gain value according to a reliability value of the focus map may be expressed as Equation 3.

$$Diff ( x , y ) = {Gain}^{( 1 )} ( x , y ) - defValue \\ {Gain}^{( 2 )} ( x , y ) = defValue + {Gain}_{c} * Diff ( x , y ) \qquad [ Equation 3 ]$$

Here, G⁽¹⁾(x, y) presents a pixel gain for image quality processing and G⁽²⁾(x, y) presents a pixel gain scaled according to a reliability value of the focus map.

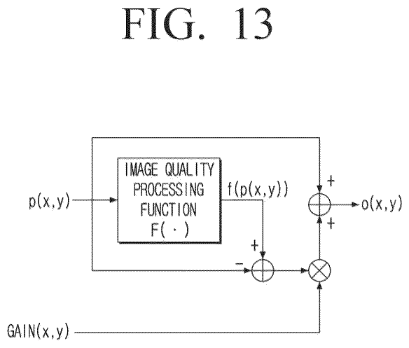

FIG. 13 is a view illustrating a detailed operation of image quality processing according to an embodiment.

According to an embodiment shown in FIG. 13, the processor 130 may adjust a difference between an image-quality processed pixel value and an input pixel value based on a gain value to perform image quality processing per region. For example, the gain value may be a value between 0 and 1 but is not limited thereto, wherein if the gain value is a specific integer size unit (e.g. 0˜255), the processor may multiply a gain value and then perform proper scaling.

According to an embodiment, an image quality processing operation may be expressed as Equation 4.

$$o ( x , y ) = gain ( x , y ) * ( f ( p ( x , y ) ) - p ( x , y ) ) + p ( x , y ) \qquad [ Equation 4 ]$$

Here, p(x, y) may be an input pixel value, f(p(x, y)) may be an image-quality processed pixel value, and o(x, y) may be an output pixel value.

According to various embodiments as aforementioned, a side effect may be prevented by highlighting image quality processing centering around the interest object region and preventing excessive image quality processing in the background region. For example, the present disclosure prevents the side effect such as a halo resulting from the condition that a boundary between an object of the interest region and the background is not exactly distinguished. Also, an image quality improvement effect may be maximized by adaptively calculating an image quality processing gain per region based on an input image characteristic and/or a type of image quality processing technology.

Meanwhile, the aforementioned methods according to various embodiments may be implemented in a form of an application installable in the existing electronic device. Also, at least part of the methods according to various embodiments of the disclosure as above may be performed by using a deep learning-based AI model, that is a learning network model.

Also, the aforementioned methods according to various examples of the disclosure may be implemented only with a software upgrade or a hardware upgrade with respect to the existing electronic device.

Also, it is possible to perform various examples of the disclosure as above through an embedded server included in the electronic device or an external server of the electronic device.

Meanwhile, according to an embodiment of the disclosure, various examples described above may be implemented as software including instructions stored in machine (e.g. a computer) readable storage media. The machine refers to a device which calls instructions stored in the storage media and is operable according to the called instructions, wherein the machine may include an electronic device (e.g. an electronic device A) according to the disclosed embodiments. If the instructions are executed by a processor, the processor may perform a function corresponding to the instructions directly or by using other components under control of the processor. The instructions may include a code generated or executed by a compiler or an interpreter. The machine readable storage media may be provided in a form of non-transitory storage media. Here, ‘non-transitory’ merely means that the storage media do not include a signal and are tangible, wherein it does not distinguish a case that data is stored in the storage media semipermanently from a case that data is stored in the storage media temporarily.

Also, according to an embodiment of the disclosure, a method according to various examples described above may be provided to be included in a computer program product. The computer program product may be traded between a seller and a buyer as goods. The computer program product may be distributed on-line in a form of the machine readable storage media (e.g. compact disc read only memory (CD-ROM)) or via an application store (e.g. Play Store™). In the case of on-line distribution, at least part of the computer program product may be stored at least temporarily or may be generated temporarily in the storage media such as memory of a server of a manufacturer, a server of an application store, or a relay server.

Also, each of components (e.g. a module or a program) according to the various embodiments above may be configured as a single item or a plurality of items, wherein a partial subcomponent of the aforementioned relevant subcomponents may be omitted or another subcomponent may be further included in various embodiments. Mostly or additionally, some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, at least part of the operations may be executed in different orders or be omitted, or another operation may be added.

As above, the examples of the present disclosure are shown and described but it is obvious that the disclosure is not limited to the aforementioned specific examples and various modifications may be implemented by those skilled in the art without deviating from the gist of the disclosure claimed in the scope of claims, wherein these modifications should not be independently understood from the technical spirit or prospect of the disclosure.

What is claimed is:

1. An electronic device, comprising:
a display;
memory storing at least one instruction; and
one or more processors connected to the display and the memory to control the electronic device,
wherein the at least one instruction, when executed by the one or more processors, causes the electronic device to:
obtain a focus map based on importance information per region included in an input image;
obtain reliability information per region of the focus map based on at least one of brightness information or contrast information of the input image and information included in the focus map;
identify sensitivity information of the focus map according to each of at least one type of image quality processing;
image-quality process the input image according to the at least one type of image quality processing based on the focus map, the reliability information per region of the focus map, and the sensitivity information; and
control the display to display the image-quality processed input image.

2. The electronic device of claim 1, wherein the at least one instruction, when executed by the one or more processors, causes the electronic device to:
identify the sensitivity information of the focus map with respect to a first type of image quality processing as relatively low and scale a value included in the focus map to become large;
identify the sensitivity information of the focus map with respect to a second type of image quality processing as relatively high and scale the value included in the focus map to become small; and
image-quality process the input image according to the at least one type of image quality processing based on the scaled focus map, the reliability information per region of the focus map, and the sensitivity information,
wherein the first type of image quality processing includes at least one of noise reduction processing or detail enhancement processing, and
wherein the second type of image quality processing includes at least one of contrast ratio enhancement processing, color enhancement processing, or brightness processing.

3. The electronic device of claim 1, wherein the at least one instruction, when executed by the one or more processors, causes the electronic device to:
downscale the input image;
identify the downscaled image as a plurality of regions and obtain a region map;
obtain a plurality of importance values according to a plurality of different characteristics with respect to each of the plurality of regions; and
obtain the focus map based on the plurality of importance values,
wherein the plurality of different characteristics include at least one of color difference information, skin color information, face probability information, or high frequency information.

4. The electronic device of claim 1, wherein the at least one instruction, when executed by the one or more processors, causes the electronic device to:
downscale the brightness information of the input image to a size of the focus map;
identify a background brightness value of the input image based on an inverse value of the value included in the focus map and the downscaled brightness information; and
obtain a first reliability gain value based on the background brightness value of the input image.

5. The electronic device of claim 4, wherein the at least one instruction, when executed by the one or more processors, causes the electronic device to:
based on the background brightness value of the input image being equal to or less than critical brightness, obtain the first reliability gain value in order that a difference value of image quality processing gains between an interest region and a background region included in the input image becomes small.

6. The electronic device of claim 4, wherein the at least one instruction, when executed by the one or more processors, causes the electronic device to:
downscale the contrast information of the input image to the size of the focus map;
identify local contrast information of the input image based on the inverse value of the value included in the focus map and the downscaled contrast information; and
obtain a second reliability gain value based on the local contrast information of the input image.

7. The electronic device of claim 6, wherein the at least one instruction, when executed by the one or more processors, causes the electronic device to:
identify a reliability level based on the first reliability gain value and the second reliability gain value; and
image-quality process the input image according to the at least one type of image quality processing based on a pixel gain value corresponding to the at least one type of image quality processing identified according to the sensitivity information of the focus map and the reliability level.

8. The electronic device of claim 7, wherein the at least one instruction, when executed by the one or more processors, causes the electronic device to:
apply the reliability level to the pixel gain value mapped per pixel region with respect to a specific type of image quality processing to update the pixel gain value; and
perform the specific type of image quality processing with respect to the input image based on the updated pixel gain value.

9. The electronic device of claim 6, wherein the at least one instruction, when executed by the one or more processors, causes the electronic device to:
apply a preset window to a pixel included in the input image to identify at least one local contrast value; and
identify a maximum value among the at least one local contrast value as the local contrast information corresponding to the pixel included in the input image.

10. The electronic device of claim 1, wherein the at least one instruction, when executed by the one or more processors, causes the electronic device to:
obtain a filtered focus map by applying at least one of temporal filtering or spatial filtering to the focus map; and
obtain the reliability information per region of the focus map based on at least one of the brightness information or the contrast information of the input image and information included in the filtered focus map.

11. A method of processing an image of an electronic device, comprising:
obtaining a focus map based on importance information per region included in an input image;
obtaining reliability information per region of the focus map based on at least one of brightness information or contrast information of the input image and information included in the focus map;
identifying sensitivity information of the focus map according to each of at least one type of image quality processing;
image-quality processing the input image according to the at least one type of image quality processing based on the focus map, the reliability information per region of the focus map, and the sensitivity information; and
displaying the image-quality processed input image.

12. The method of claim 11, wherein the image-quality processing includes:
identifying the sensitivity information of the focus map with respect to a first type of image quality processing as relatively low and scaling a value included in the focus map to become large;
identifying the sensitivity information of the focus map with respect to a second type of image quality processing as relatively high and scaling the value included in the focus map to become small; and
image-quality processing the input image according to the at least one type of image quality processing based on the scaled focus map, the reliability information per region of the focus map, and the sensitivity information,
wherein the first type of image quality processing includes at least one of noise reduction processing or detail enhancement processing, and
wherein the second type of image quality processing includes at least one of contrast ratio enhancement processing, color enhancement processing, or brightness processing.

13. The method of claim 11, wherein the obtaining the focus map includes:
downscaling the input image and identifying the downscaled image as a plurality of regions to obtain a region map; and
obtaining a plurality of importance values according to a plurality of different characteristics with respect to each of the plurality of regions and obtaining the focus map based on the plurality of importance values,
wherein the plurality of different characteristics includes at least one of color difference information, skin color information, face probability information, or high frequency information.

14. The method of claim 11, wherein the obtaining the reliability information per region of the focus map includes:
downscaling the brightness information of the input image to a size of the focus map;
identifying a background brightness value of the input image based on an inverse value of the value included in the focus map and the downscaled brightness information; and
obtaining a first reliability gain value based on the background brightness value of the input image.

15. A non-transitory computer readable medium storing computer instructions that when executed by a processor of an electronic device, cause the electronic device to:
obtain a focus map based on importance information per region included in an input image;
obtain reliability information per region of the focus map based on at least one of brightness information or contrast information of the input image and information included in the focus map;
identify sensitivity information of the focus map according to each of at least one type of image quality processing;
image-quality process the input image according to the at least one type of image quality processing based on the focus map, the reliability information per region of the focus map, and the sensitivity information; and
display the image-quality processed input image.

16. The non-transitory computer-readable medium as claimed in claim 15,
wherein the image-quality processing includes:
identifying the sensitivity information of the focus map with respect to a first type of image quality processing as relatively low and scaling a value included in the focus map to become large;
identifying the sensitivity information of the focus map with respect to a second type of image quality processing as relatively high and scaling the value included in the focus map to become small; and
image-quality processing the input image according to the at least one type of image quality processing based on the scaled focus map, the reliability information per region of the focus map, and the sensitivity information,
wherein the first type of image quality processing includes at least one of noise reduction processing or detail enhancement processing, and
wherein the second type of image quality processing includes at least one of contrast ratio enhancement processing, color enhancement processing, or brightness processing.

17. The non-transitory computer-readable medium as claimed in claim 15,
wherein the obtaining the focus map includes:
downscaling the input image and identifying the downscaled image as a plurality of regions to obtain a region map; and
obtaining a plurality of importance values according to a plurality of different characteristics with respect to each of the plurality of regions and obtaining the focus map based on the plurality of importance values,
wherein the plurality of different characteristics includes at least one of color difference information, skin color information, face probability information, or high frequency information.

18. The non-transitory computer-readable medium as claimed in claim 15,
wherein the obtaining the reliability information per region of the focus map includes:
downscaling the brightness information of the input image to a size of the focus map;
identifying a background brightness value of the input image based on an inverse value of the value included in the focus map and the downscaled brightness information; and
obtaining a first reliability gain value based on the background brightness value of the input image.

19. The non-transitory computer-readable medium as claimed in claim 18, wherein obtaining a first reliability gain value includes:
based on the background brightness value of the input image being equal to or less than critical brightness, obtaining the first reliability gain value in order that a difference value of image quality processing gains between an interest region and a background region included in the input image becomes small.

20. The non-transitory computer-readable medium as claimed in claim 18,
wherein the obtaining the reliability information per region of the focus map includes:
downscaling the contrast information of the input image to a the size of the focus map;
identifying local contrast information of the input image based on the inverse value of the value included in the focus map and the downscaled contrast information; and
obtaining a second reliability gain value based on the local contrast information of the input image.
